(19) United States
(12) Patent Application Publication
(10) Pub. No.: US 2008/0185159 A1
(43) Pub. Date: Aug. 7, 2008

(54) Foam fire suppression apparatus

(75) Inventor: Donald W. Walsh, Chicago, IL (US)

Correspondence Address: PENNIE & EDMONDS, 1155 AVENUE OF THE AMERICAS, NEW YORK, NY, 100362711, US

(73) Assignee: CITY OF CHICAGO

(21) Appl. No.: 11/702,699

(22) Filed: Feb. 6, 2007

(51) Int. Cl. A62C 35/64

(52) U.S. Cl. 169/14

(57) ABSTRACT

An apparatus for foam suppression of fire is presented as being configured for use in new or preciously existing structures and using a non-fire-suppression-dedicated water supply.

### FIELD OF THE INVENTION

The present invention relates generally to an apparatus for fire suppression in a building, and specifically to a system and methods for providing a fire suppression water-foam extinguishing sprinkler apparatus in a building using a non-fire-suppression-dedicated water supply of the building.

### BACKGROUND

Newly constructed multi-level buildings typically include a sprinkler system for fire protection. In such buildings, a dedicated, high-volume standpipe is provided, running generally vertically from a water supply main (e.g., in a lower level of the building). The dedicated standpipe extends up to most or all floors of the building that include outlets of the sprinkler system. Systems known in the art may include a water pump near the base of the dedicated standpipe and/or one or more “booster pumps” such as, for example, hydropneumatic pumps (particularly in high-rise buildings) to maintain a desirable water pressure in the system. The dedicated standpipe is connected in fluid communication with a network of sprinkler outlets configured to spray water in an area of the building affected by a fire. Typically, the water pump(s) must provide sufficient water pressure to meet local building code requirements regarding flow rate and/or pressure requirements. In buildings that do not include a plumbed sprinkler system, one or more dedicated standpipes (including one or more pumps) may be provided with one or more fire hoses at designated locations on each floor.

Many older residential and commercial buildings pre-date the building codes that mandate a sprinkler system or other fire suppression system. In other words, those buildings include no water-flow-based type fire suppression system at all. Many such buildings were exempted when a fire suppression mandate was imposed in building codes. However, it is desirable to provide a fire suppression system in such buildings. This is primarily for the safety of its residents, but also to comply with updated building codes in some municipalities, which have required existing structures to implement/install fire suppression systems. Retrofitting an existing building by providing a fire suppression system with a dedicated standpipe and sprinkler network, or even a hose system, as described above is often prohibitively expensive as it may require installing one or more pumps as described above along with a high-volume dedicated standpipe through most or all floors of the building in addition to a sprinkler network. Therefore it is also desirable to provide a fire suppression system that is configured to provide a cost savings while providing fire suppression functionality concordant with desirable safety standards and compliant with relevant building codes.

### BRIEF SUMMARY

Therefore, in one aspect the present invention includes providing a fire suppression apparatus in an existing building and utilizing a multi-purpose or non-fire-suppression-dedicated water source such as, for example, one or more of a municipal water main, an existing potable water standpipe, an existing gray water source, a low-pressure water supply line, and/or another water supply source that is not dedicated to fire suppression. In such an aspect, it may be advantageous to increase the pressure of flow for the water and/or for a foam component to be combined therewith. For example, standard water pressure in city mains and feeder lines associated with the City of Chicago water works is typically at about 32 PSI (lbs./in²). In a typical fire standpipe in a structure such as a commercial or residential building, a “house pump” may be used to increase the pressure of water flow to as much as 170 PSI. By comparison, the non-fire-suppression-dedicated water supply of a non-fire standpipe that supplies potable water for drinking water, toilets, showers, and other domestic water fixtures may function at about 8 to 20 PSI. In a system of the present invention, an appropriate pressure in a water supply line may vary depending upon the room size and number of sprinklers heads to be supplied.

And, in another aspect, the present invention includes providing a fire suppression apparatus in a newly-constructed building and utilization of a multi-purpose or non-fire-suppression-dedicated water supply source such as, for example, one or more of a municipal water main, an existing potable water standpipe, a low-pressure water supply line, and/or another water supply source that is not dedicated to fire suppression.

In particular, one aspect of the invention provides for utilization of an existing water supply standpipe, which is not a dedicated fire-suppression standpipe, in a single-level or multi-level building along with a pressurized system for providing a fire suppression foam component to be mixed with water and dispersed through a plurality of manifolds (e.g., high pressure manifolds such as sprinkler heads or other appropriate sprayers or spray valve structures). The inventor of the present invention discovered surprisingly that, in spite of decades of work retrofitting existing buildings with fire suppression systems, no system provided an effective economic fire suppression system utilizing the existing water supply standpipe with a foam and pressurized fluid system. In some embodiments, a system of the present invention may provide-single fire suppression assembly for a building, one or more fire suppression assemblies per building level (e.g., a plurality of assemblies corresponding to a plurality of fire protection zones), or one or more fire suppression assemblies for a chosen plurality of building levels.

In certain embodiments, pressurization of water and foam for forming a fire-suppression mixture may be provided by a fluid pressurization component such as, for example, a hydraulic compressor, an air compressor, a compressed gas tank, or a pressurization pump such as a pressurization pump configured to increase ambient water pressure.

In some embodiments, a foam component (such as, for example, a foam concentrate) for a fire-suppression mixture may be stored in a bladder-tank component of a type known in the art or future-developed type and then introduced into the fire suppression system by fluid pressure such as system water pressure, pressure from a compressed fluid (e.g. a gas, or a hydraulic system) being exerted, for example, upon the bladder. In these and other embodiments, the foam component may be mechanically pumped out of a holding tank (e.g., a standard foam storage tank) or aspirated therefrom for mixing with water. Specifically, foam may be introduced by aspiration by providing a foam-flow path to a water line, wherein the path is configured such that water flowing through the water line creates a lower pressure than in the foam-flow path and draws foam into the water. As used herein, the term “foam” includes foam concentrate and expanded foam concentrate as well as the foam component of a fire-suppression mixture that includes foam with one or more of air, water, or another fluid.

In one aspect, an embodiment of the present invention may include a fire suppression apparatus that is configured for use in a building structure. The apparatus includes a sprinkler head, a conduit providing fluid communication to the sprinkler head from a non-fire-suppression-dedicated water source having a pressure; a control module, a foam source, and a compressed gas component. The foam source is in fluid communication with the conduit via the control module, and the compressed gas component is in fluid communication with the conduit. The compressed gas component preferably is configured for increasing a pressure in the conduit above the water source pressure.

In another aspect, an embodiment of the present invention may include a fire suppression apparatus that is configured to be installed as a retrofit device in a pre-existing building structure. The apparatus includes a sprinkler head, a conduit providing fluid communication to the sprinkler head from a non-fire-suppression-dedicated water source having a pressure; a control module, a foam source, and a compressed gas component. The foam source is in fluid communication with the conduit via the control module, and means for increasing a pressure in the conduit above the water source pressure.

In yet another aspect, an embodiment of the present invention may include a method for providing a fire suppression system in a building structure. The method includes the steps of: connecting a non-fire-suppression-dedicated water source into fluid communication with a sprinkler head via at least one conduit; providing a foam source connected in fluid communication with the at least one conduit and thereby with the sprinkler head; and providing a control module configured to control a flow of foam from the foam source into the conduit.

In still another aspect, an embodiment of the present invention may include a fire suppression apparatus configured to be installed in a building structure where the apparatus includes a sprinkler head, a conduit providing fluid communication to the sprinkler head from a non-fire-suppression-dedicated water source having a pressure, a control module, a foam source that is in fluid communication with the conduit via the control module, and means for increasing a pressure in the conduit above the water source pressure.

### BRIEF DESCRIPTION OF THE DRAWINGS

FIG. 1A shows a diagrammatic section view of a first embodiment of a fire suppression system, installed in a multi-level building;

FIG. 1B depicts a diagrammatic section view of a second embodiment of a fire suppression system, installed in a multi-level building;

FIG. 2 illustrates a diagrammatic top view of a floor level from the building of FIG. 1A;

FIG. 3 shows, in block diagram form, a system assembly of the present fire suppression system;

FIG. 4 diagrammatically depicts a control module embodied as a balanced pressure proportioning connection; and

FIG. 5 illustrates, in diagrammatic fashion, another embodiment of a fire suppression system of the present invention.

### DETAILED DESCRIPTION

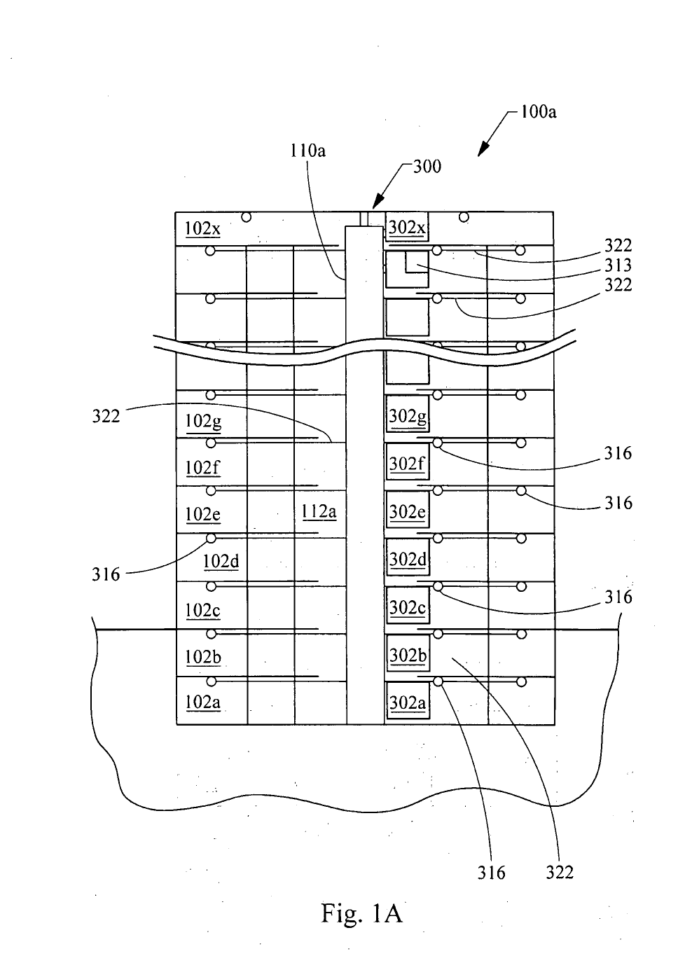

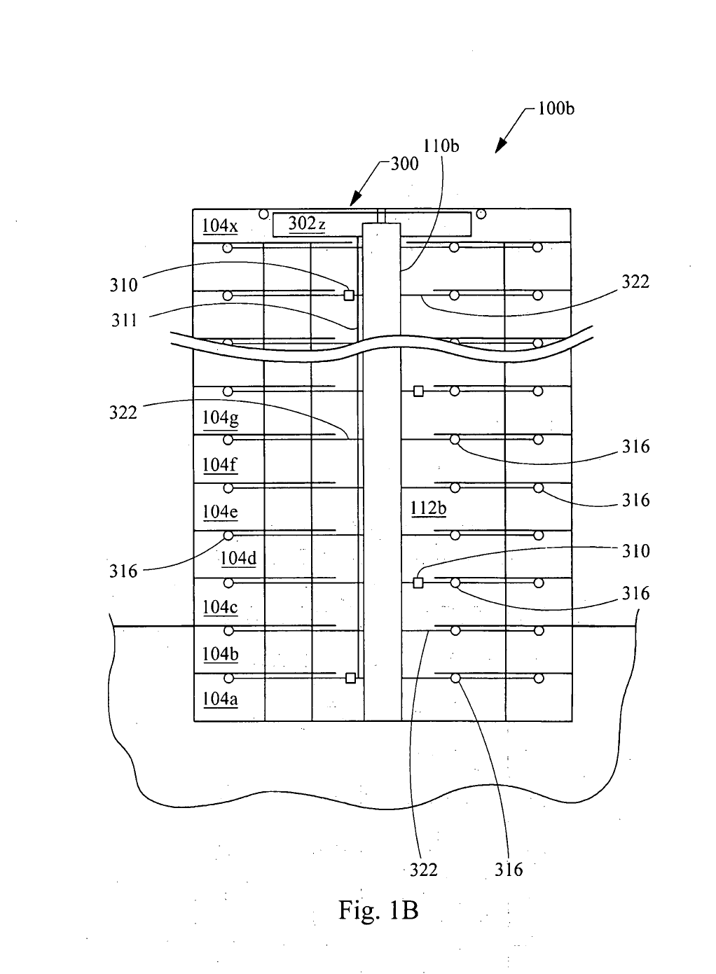

Embodiments of a fire suppression system 300 are illustrated with reference to FIGS. 1-3. The fire suppression system is shown as being provided in a pre-existing building 100a, 100b. As shown in FIGS. 1A-1B the building 100a, 100b is a multi-level structure. It should be appreciated that a fire suppression system of the present, invention may be implemented in a building with a different configuration and dimensions (e.g., number of levels, general layout, etc.), and that the building need not be pre-existing as a new building may be constructed with a fire suppression system of the present invention.

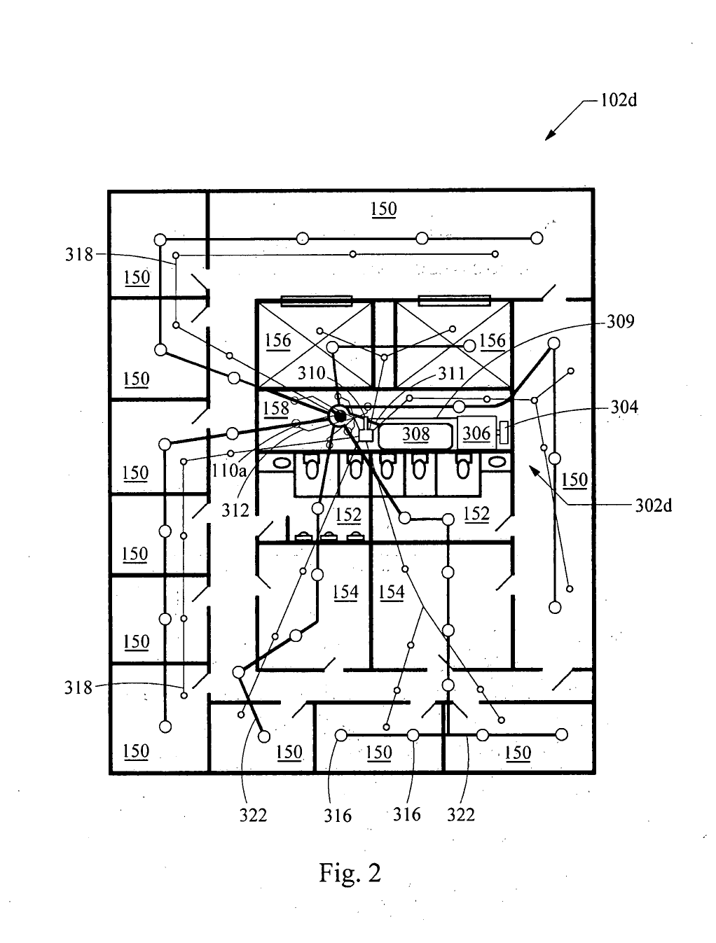

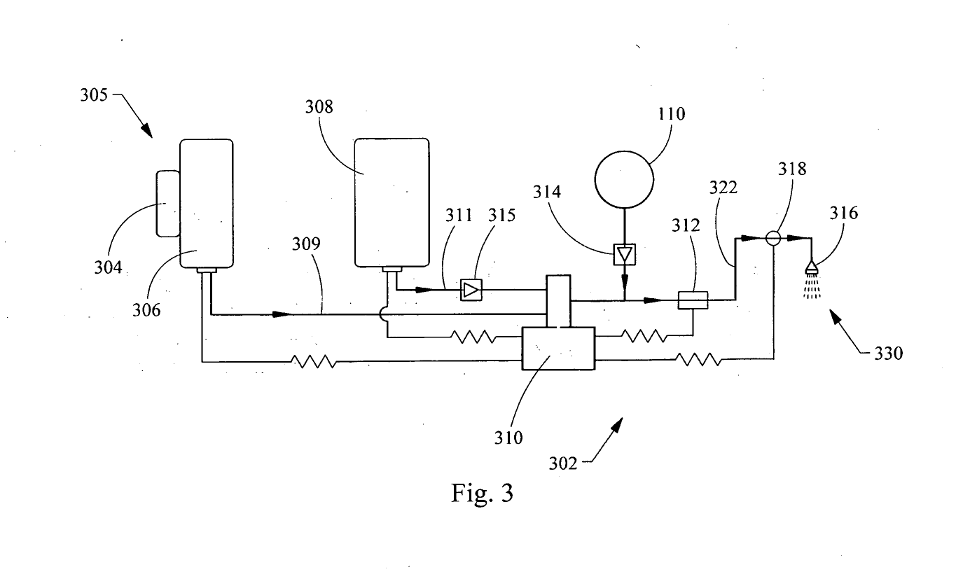

As is described in greater detail below, with reference to a first embodiment illustrated in FIG. 1A, a fire suppression system 300 may be configured in a somewhat decentralized manner with multiple system assemblies 302a-302x in a multiple locations in the building 100b (such as, for example, with one or more assemblies on each level, or on every 2nd, 3rd, 5th . . . level, etc.). As is also described in greater detail below, in a second embodiment illustrated in FIG. 1B, the fire-suppression system 300 may be configured in a centralized manner with a centralized system assembly 302 in a single location in the building 100b. Although the dimensions of the system assembly 302, 302a-302x may differ in size and functional capacity, the basic components are substantially the same and are described with reference to FIG. 3, which is depicted in block diagram form. FIG. 2 illustrates an example of a floor layout 200 in the building 100a.

FIG. 1A depicts a multi-level building 100a having several levels 102a-102x. As illustrated, the lowermost two levels 102a, 102b are below ground level. However, it should be noted that levels below ground level are not required, and the present invention may be used in virtually any new or existing structure including, for example, single-level single family houses, elevated/“stilt” houses, single-level and multi-level multi-family/multi-use structures, and high-rise buildings. The building 100a includes a central standpipe 110a configured to provide water to the sinks, lavatories, and water fountains of the building, but is not a fire-suppression-dedicated standpipe. The central standpipe 110a is connected to a water supply main (not shown) in the lowermost building level 102a, and may extend upward through a central pipe chase 112a or other appropriate pathway (such as, for example, a stairway or elevator shaft of a building) to the uppermost building level 102x.

FIG. 1B depicts a multi-level building 100b having several levels 104a-104x. As illustrated, the lowermost two levels 104a, 104b are below ground level. The building 100b includes a central standpipe 110b configured to provide water to the sinks, lavatories, and water fountains of the building. The central standpipe 110b is shown as being connected to a water supply main (not shown) in the lowermost building level 104a, and extending upward through a central pipe chase 112b to the uppermost building level 104x. A single system assembly 302z is disposed in the upper level 104x.

FIG. 3 illustrates one embodiment of a system assembly 302 of the present invention. The system assembly 302 is here described generally with reference to structures of FIGS. 1A-1B, and is described below with more particular reference to the system 300 embodiments of FIGS. 1A and 1B. The system assembly may include a pressurization unit 305 having a fluid pressurization unit 304, which may be connected in fluid communication with a pressurized fluid-holding component 306, or which may be configured to introduce pressurized fluid without a pressurized fluid-holding component. In one embodiment, the pressurization unit 304 is embodied as an air compressor and the pressurized fluid-holding component 306 is embodied as a compressed air tank (wherein the pressurized fluid is air). In alternative embodiments, the pressurized fluid-holding component 306 may utilize a tank of a compressed gas that preferably is not a combustion-supporting gas (e.g., carbon dioxide, nitrogen). The pressurized fluid-holding component 306 may also be equipped with a rapid-pressure-release valve in order to allow the pressurized fluid to be vented quickly in the event that the pressurized fluid-holding component 306 is subjected to sufficient heat (e.g., during a fire) that it would risk rupture due to thermal expansion of the pressurized fluid. In still other embodiments, pressurization may be provided by one or more pumps such as mechanical pumps. The pressurized fluid holding component 306 illustrated in FIG. 3 may be connected in electronic communication with a control module 310 that controls flow through a fluid conduit 309, which is connected in fluid communication with a common conduit 322.

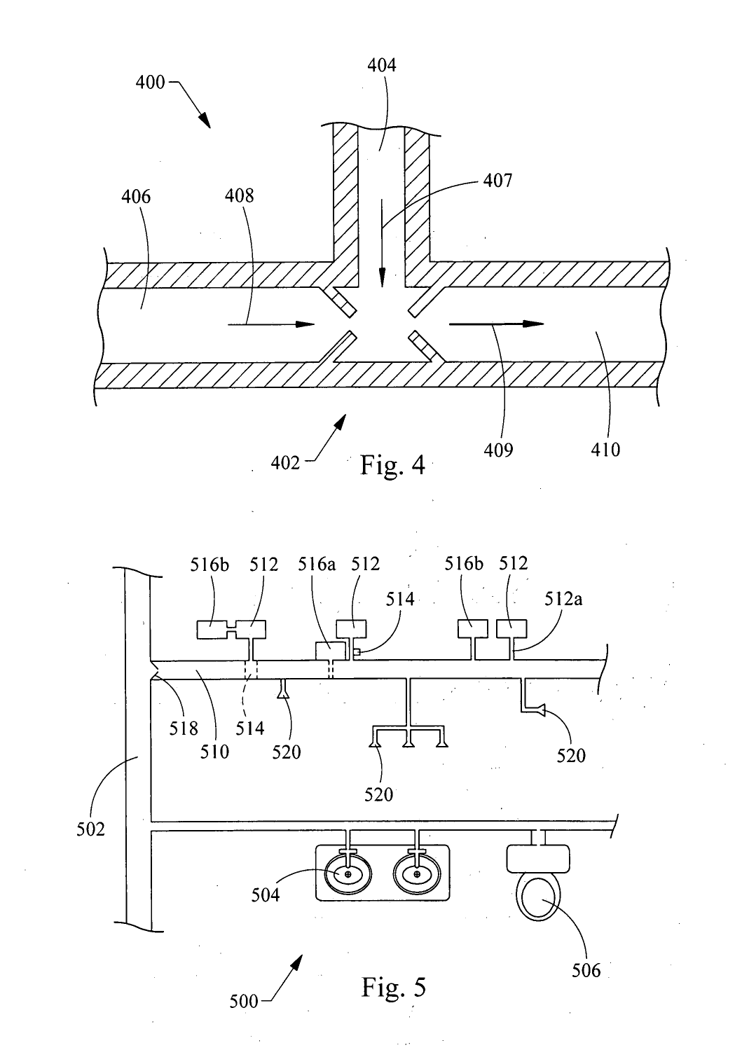

The control module 310 is depicted in FIG. 3 as an electronic control module. However, it should be appreciated that a control module of the present invention may be configured as a mechanical control module with no electronic components. Specifically, many different mechanical flow controllers are known in the art and many of these are appropriate for use as a control module within the scope of the present invention. For example and as shown diagrammatically in FIG. 4, a control module embodied as a balanced pressure proportioning connection 400, of a type known in the art, may use a static structure 402 at a junction of a foam supply line 404 with a water supply line 406 to mix foam (arrow 407) and water (arrow 408) at a predetermined ratio to form a foam-water mixture (arrow 409) that flows through a conduit 410 (for example, to deliver the mixture 409 through a sprinkler head or other appropriate manifold structure (not shown)). In other words, the control module may be embodied as a valve or any number of other mechanical and/or electronic control structures for providing a desirable foam-water mixture, including those with static components or with moving components, such as are known and/or will be apparent to those in the art for use within the scope of the present invention.

The control module 310 of the illustrated embodiment includes electronic monitoring and control components that control mechanical components of the system assembly for modulating mixture and flow therethrough (see, for example, a control system such as used with the Ansul OP0006, FoamPro® AccuMax®, or other systems. A foam source embodied as a foam supply tank 308, which may include a foam pump (such as, for example, a Hale 8FG, Hypro Twin Plunger-pump, Paxon® pump, pumps made or recommended by CET Fire Pump Mfg., W.S. Darley & Co., Kidde, U.S. Foam Technologies, National Foam, or various other foam pump systems known in the art (not shown)), or a hydropneumatic or jockey pump, is also connected in fluid communication via a foam conduit 311 with the common conduit 322. If no pump is present, the foam may be pressurized in the foam tank 308 or may be aspirated into the foam conduit 311 when negative pressure is created therein by activation of water flow downstream. The foam supply tank 308 may be configured to provide a foam concentrate through the foam pump at a rate controlled by the control module 310. The system may also include a fluid pressurization unit 304 and fluid-holding component 306 of the fluid supply unit 305, but a system may also include a foam material system that does not require pressurized fluid for mixing or pressurization of the system in order to deliver a fire-suppression mixture. It should be appreciated that—as used herein—the terms “foam source” and “tank” encompass various types of tanks, bladders, or other appropriate storage devices may be used for foam, compressed fluid, and/or water within the scope of the present invention.

Foam mixtures such as those available from U.S. Foam Technologies, National Foam, Pros-Chek, Hale, Kidde, Tyco, and Pentair are known within the art to provide superior fire-suppression properties as contrasted with plain water. As compared to water, foam-water mixtures provide greater surface area for absorption of heat, and they act in a surfactant fashion. By acting in a surfactant fashion, the mixture can coat walls, ceilings, and other surfaces (including surfaces of flammable liquids) more effectively and efficiently than water, which tends to run off more quickly. This promotes less saturation of the material being coated, making it easier to clean up later and reducing damage as compared to water. These properties of foam-fluid mixtures render them effective for suppressing fire classes A, B, and C (generally, fires affecting ordinary combustibles such as building materials and furnishings, flammable liquids, and energized electrical equipment, respectively). This coating effect is known to provide superior heat absorption, and also creates a barrier between the surfaces and the oxygenated air, thus directly attacking combustion. Compressed air foam (CAF) is known to be even more effective than just foam-water mixtures. Introduction of a compressed fluid such as compressed air to form a foam-air-water mixture enhances the surfactant properties over straight foam-water mixture, and the introduction of compressed air creates smaller bubbles thereby increasing fluid surface area.

In the illustrated embodiment, the fluid supply unit 305 operates to provide a pressure for propelling a fire-suppression mixture through a desired path at a pressure greater than or equal to that which is typically provided by a water supply that is not dedicated to fire-suppression. In an alternative to the structure shown in FIG. 3, the fluid supply unit 305 may be connected directly to the foam supply tank 308 or foam conduit 311 to provide a desired flow pressure.

In the illustrated embodiment, the non-fire-suppression-dedicated water source is embodied as a standpipe 110a, 110b, which is connected in fluid communication with the common conduit 322, preferably downstream of the fluid conduit and foam conduit connections. The water flow from the standpipe to and through the common conduit 322 has a pressure that may be generated by the standard pumping/pressure configuration of the existing system. However, for purposes of fire suppression, it may often be desirable to maintain a water pressure that is greater than typically provided by a non-fire-suppression-dedicated potable water supply. Thus, the water pressure may be increased with fluid pressure (such as air pressure from a fluid supply unit 305) or with one or more pumps. Specifically, one or more pumps 313 may be provided to increase water pressure in a common conduit 322 to a pressure equal to or greater than a water pressure present in a non-fire-suppression-dedicated water supply such as a potable water standpipe. For example, the 2006 building code for the City of Chicago requires that a water fire-suppression system supply a minimum sprinkler-head residual pressure of 15 PSI at 20 gallons per minute (gpm) (see Municipal Code of Chicago, Ill. § 15-16-270), and one preferred embodiment of the present invention may be configured to meet this standard.

Preferably, at least a single one-way valve 314 (also known as a check valve) will be disposed between the water standpipe 110a, 110b and the common conduit 322 (and more than one such valve may be so disposed) to minimize the risk of foam or other components getting into and contaminating the water supply of the standpipe 110a, 110b. Preferably, a one-way valve 315 will also be disposed upstream of the water supply connection to prevent retrograde water flow (also known as backflow or back-siphonage) and keep water from backing up into the foam supply 308. The control module 310 operates to control the creation of a fire suppression mixture 330 (e.g., a fluid-foam-water mixture, such as an air-foam-water mixture, or a fluid-foam mixture).

Downstream of its connection with the water supply 110a, 110b, the common conduit 322 may be connected in fluid communication to or through a flow meter 312. When present, a flow meter 312 may provide a flow monitoring function with electronic or other feedback 310z to the control module 310 such that the control module can modulate the flow rate of the foam to dynamically provide an appropriate fire suppression mixture 330. In turn, the flow meter 312 is connected in fluid communication with one or more sprinkler head(s) 316 such as, for example, a high pressure manifold or other appropriate sprayer, spray valve, or other sprinkler head type known in the art and configured for dispersing a fluid-foam-water (or, as the case may be, foam-water) mixture in a fashion suitable for fire suppression. The sprinkler heads 316 may be, for example, of a self-activating type that open up to allow water flow upon exposure to a particular high temperature. Another component that may be incorporated is a delivery activation component 318, which includes a sensor for detecting temperature, smoke, and or flame and communicating with the control module 310 to modify flow of the fire suppression mixture 330. Examples of detection components that could be used or adapted for use within the present system include, for example, the multi-sensor device described in U.S. Pat. No. 7,068,177, which is incorporated by reference herein; alternatively, a detection component 318 may be integrated into a sprinkler head 316 such as is described, for example, in U.S. Publ. App. No. 2005/0145395, which is incorporated by reference. Those of skill in the art (including at least those skilled in the fire prevention and building constructions trades) will also appreciate that a system assembly of the present invention may coordinate signals from the flow meter 312 and the delivery activation component 318 through the control module to deliver an appropriate fire suppression mixture 330 to locations in need of the same.

In particular, the delivery activation component 318 may be configured in a “highly localized” manner so that an appropriate number of the components is distributed throughout the building such that one component 318 is associated with the sprinkler head(s) in each room or localized fire-control zone of a building, and further configured such that the control module 310 will provide a fire suppression mixture only to a location where the delivery activation component is activated. Alternatively, the delivery activation component 318 may be “delocalized” so that a plurality of such components are part of the system and each component is associated with the sprinkler head(s) of an entire level or large (e.g., multi-level) fire control zone of a building, wherein the control module would provide a fire suppression mixture to broad area around where the delivery activation component was activated. In one embodiment, the pressurized fluid holding component 306 is configured to provide a pressure in the system assembly 302 such that a flow of a fire-suppression mixture 330 is provided through the one or more sprinkler heads 316 at a pressure sufficient to effectively dispense the mixture 330 and/or to comply with relevant statutory and industry practice standards.

The common conduit 322 provides a path of fluid communication from the water source 110 to a sprinkler head such the sprinkler head 316 shown in FIG. 3. The foam supply 308 is in fluid communication with the common conduit 322. The fluid pressurization unit 305, if present, is also in fluid communication with the common conduit 322. If a fluid pressurization unit is not present, another pressurization means such as, for example, a pump, may be in communication with the common conduit 322 to increase a pressure therein above a pressure provided by the water source 110 and/or foam supply 308.

Fire suppression systems of FIGS. 1A-1B are described with reference to the components of FIG. 3. In a first, decentralized, embodiment of the fire suppression system 300 shown in FIG. 1A, a system assembly 302(a-x) as described above may be installed on each level, or—alternatively—on alternating level (e.g., every 2nd, 3rd . . . level). In this embodiment, each of the levels 102a-102x is provided with a fire suppression system assembly.

FIG. 2 shows a particular example of a system assembly 302 in greater detail. Shown as a diagrammatic top view of level 102d from FIG. 1A, FIG. 2 depicts a floor plan incorporating a fire suppression system assembly 302d. The floor plan of level 102d includes a plurality of outer rooms 150, lavatories 152, inner rooms 154, elevator shafts 156, and a central pipe chase 158 housing a standard non-fire-suppression-dedicated water standpipe 110a that supplies the lavatories, etc.

The fire suppression system assembly 302d is shown as having been installed in the pipe chase 158 and is depicted in the same manner as described above with reference to FIG. 3. (It should be appreciated that one or more units of a system assembly 302d may be installed elsewhere such as, for example, in a service room area, above a suspended ceiling over one or more of the rooms, or any other appropriate location). The water standpipe 110a is connected to the conduit 322, which extends and branches out to the multiple sprinkler heads 316. A delivery activation component 318 is shown as installed adjacent each sprinkler head 316. Each of the other levels having a system assembly 302 installed may be similarly configured (although those of skill in the art will appreciate the great flexibility of the system with regard to the potential number and placement of system components). Each of a plurality of foam conduits may be provided with auxiliary control modules (not shown) to more exactingly control the proportions in a fire suppression mixture being directed to particular locations. In the illustrated system assembly, the main control module 310 may act as a hub for receiving signals from the flow meters and detection/delivery actuation devices, and utilizes the auxiliary control modules to control the delivery and content of the fire suppression mixture passing therethrough.

In a second, centralized, embodiment of the fire suppression system 300 depicted in FIG. 1B, the core elements (foam and fluid pressure components, and control module—not shown individually) of a system assembly 302b as described above are installed in a single location (e.g., a central floor or a top floor). In this embodiment, each of the levels 104a-104x is provided with the sprinkler head (316), flow monitor (not shown), and detection/delivery activation (not shown) components, as well as the electronic and fluid communication means (not shown) between them and the core elements. The fire suppression system assembly 302d is depicted in the same manner as described above with reference to FIG. 3. The water standpipe 110a is connected to conduits 322 at each level, which connect to a foam supply conduit 311 then extend and branch out to the multiple sprinkler heads 316. Single or multiple flow control units 310 may be provided on each level to provide a main control unit 310 with information needed to modify the foam supply for providing an appropriate fire suppression mixture 330. Those of skill in the art will appreciate the great flexibility of the system, including for example that the number and location of detection components 318 and flow monitors may be varied as desired. In addition, for both of the first and second embodiments described herein as well as other embodiments, multiple control units may be provided and associated with one or more fluid supply 304, 306 and foam supply 308 units.

In another aspect, a method of implementing a fire suppression system of the present invention may include the following steps: (a) Determining one or more appropriate locations in a building for installing a fire suppression system in connection with a water source that is not dedicated to fire suppression; (b) Determining one or more appropriate locations in the building for installing a system assembly of the fire suppression system; (c) Providing a pressurized fluid source, foam storage chamber, control module, and conduit with a one-way connection from the water standpipe for combining the water, fluid, and foam in a fire suppression mixture; and (d) Providing further conduit and sprinkler heads configured to provide a path of fluid communication for the fire suppression mixture to one or more locations in the building (e.g., rooms, elevator shafts), including one or more flow meters in electronic communication with the control module; and may also include one or more detection/delivery activation components in electronic communication with the control module.

In still another aspect, a method of the present invention for suppressing a fire may include the steps of (a) providing a water supply from a non-fire-suppression-dedicated water line; (b) providing a foam supply; (c) mixing the water and foam at a location in a building; and (d) dispensing the water-foam mixture to a fire location. The method may further include providing a compressed gas to increase the pressure of the mixture and/or to provide a CAF mixture. The method may also include activating a pump connected to the water line to increase the pressure therein.

During an exemplary operation of a fire suppression system embodiment 300 that includes one or more detection/delivery activation components 318, an increased temperature of a structural level associated with a fire triggers a sensor in the activation component 318, which signals the control module 310 and actuates opening of sprinkler heads 316 which allows a water flow to begin. The control module 310 activates the pressurized fluid chamber 306 and foam tank 308. At the same time, the control module 310 monitors and utilizes a signal from a flow meter 312 to modulate the foam flow to produce an appropriate fire suppression mixture 330, which is directed to and through the sprinkler heads 316 to the target area.

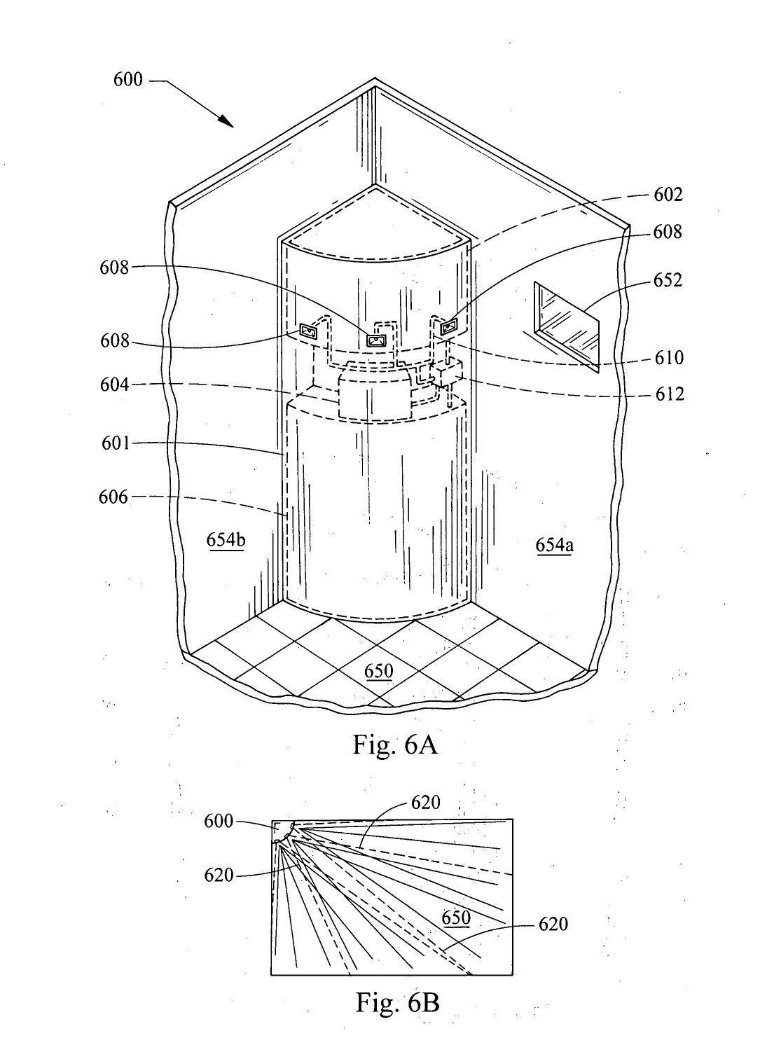

Another diagrammatic representation of a fire suppression system embodiment is shown as a system 500 in FIG. 5 (not shown to scale). A water supply line 502 provides water to standard water fixtures such as a sink 504 and toilet 506. In addition, the water supply line 502 provides water to a fire suppression conduit 510. A foam supply unit 512 may be connected in fluid communication with the fire suppression conduit 510 by a control module 514 (such as, for example, a mechanical or electronic controller configured to modulate the foam-water mixture), or a foam conduit 512a may be constructed to function as a control module to modulate foam flow into the fire suppression conduit 510. A fluid-pressurization unit such as a pump 516a and/or a compressed gas unit 516b may be connected to the foam supply unit 512 and/or to the fire suppression conduit 510.

The fluid-pressurization unit, if present, may be configured to increase the pressure in the fire suppression conduit 510 above the pressure provided by water in the water supply line 502. The fluid pressurization unit may also be configured to introduce a compressed gas such as compressed air to the foam and water to form a CAF mixture. The system 500 may include a one way valve 518 to minimize the likelihood of foam or other material from being transferred from the fire suppression conduit 510 to the water supply line 502. The system 500 may also include one or more sprinkler heads 520, nozzles, or other structures connected in fluid communication with the fire suppression conduit 510 and configured to deliver a fire suppression mixture including an appropriate combination of water, foam, and/or air.

In another system embodiment, a fire suppression assembly may be embodied as a freestanding fire-suppression system 600, embodiments of which are described with reference to FIGS. 6A-6B. By “freestanding,” it is meant that the system 600 is not installed in a traditional service area of a building as described above (e.g., elevator shaft, pipe chase, etc.). Rather, the system may generally be contained in a housing and be configured to be installed in a room or other structural area as a unit. For example, FIGS. 6A-6B depict a system 600 that is generally contained in a housing 601 that is generally shaped as a section of a cylinder and installed in the corner of a room 650 at the junction of a first wall 654a (shown as having a window 652) with a second wall 654b. Those of skill in the art will appreciate that the system may be configured in a variety of geometries and may be installed in almost any area of a room, including being generally within or suspended from a ceiling (the location preferably providing a spray path to a substantial portion of the room).

In the embodiment pictured in FIG. 6A, the system 600 includes a foam tank 602 configured to hold a fire-suppressant foam concentrate. A pressurization source 604 is provided, and may be embodied in any of the ways described above with reference to other embodiments (including, for example, an air compressor assembly, a pump, or other pressurization assembly known or developed in the art). A water source 606 is also provided. In the illustrated embodiment, the water source is a water-holding tank 606. In some embodiments, the tank 606 may be connected to a non-fire-suppression-dedicated water line such as a potable water line of the type described above.

The water source 606, foam tank 602, and pressurization source 604 are all connected in fluid communication with a control module 612, which—as described above with reference to other embodiments—may be embodied as a valve, electronic controller, or other structure configured to mix water and foam to form a fire-suppression mixture 620. In an embodiment where the pressurization source 604 provides compressed air, the fire-suppression mixture 620 may be a CAF mixture of the type described above. The control module 612 is connected in fluid communication with sprinkler heads 608 by a conduit 610. The sprinkler heads 608 preferably are configured to provide spray coverage of a predetermined area of a room or other installation site. FIG. 6B shows a top view of one example of how a corner-mounted unit such as, for example, the system 600 of FIG. 6A may be used to dispense a fire-suppression mixture 620 throughout a room 650. Those of skill in the art will appreciate that a variety of sensing and/or actuation mechanisms known or developed in the art, but not shown here, may be used to activate the system.

Those of skill in the art will recognize and appreciate that each of the components of the system embodiments described above may be commercially in use or available and adaptable for use from the array of currently-available devices being used in structural and mobile fire suppression systems (e.g., systems and components available from, for example, FoamPro®, US Foam Technologies, Inc., Reliable Fire Equipment Company, or Gielle Group). Additionally, those of skill in the art will appreciate that a non-fire-suppression-dedicated water source is a common feature expected in the environments (e.g., new or pre-existing building structures) where an embodiment of the present invention may be used, and therefore is not claimed as part of the invention.

It is therefore intended that the foregoing detailed description be regarded as illustrative rather than limiting. It should be understood that the following claims, including all equivalents, are intended to define the spirit and scope of this invention.

1. A fire suppression apparatus for use in a building structure, the apparatus comprising:
a sprinkler head;
a conduit providing fluid communication to the sprinkler head from a non-fire-suppression-dedicated water source having a water source pressure;
a control module;
a foam source, the foam source being in fluid communication with the conduit via the control module; and
means for increasing a pressure in the conduit above the water source pressure.

2. The fire suppression system of claim 1, further comprising a flow meter in electronic communication with the control module, the flow meter being configured to measure a flow of water, and to communicate said measurement to the control module.

3. The fire suppression system of claim 1, wherein
a first conduit portion of the conduit is disposed in an upstream direction from a junction of the foam source with the conduit and
a second conduit portion of the conduit is disposed downstream from the junction.

4. The fire suppression system of claim 3, wherein the means for increasing pressure comprises a pressurized fluid assembly that is configured to provide a flow of pressurized fluid to the first conduit portion.

5. The fire suppression system of claim 4, wherein the pressurized fluid is air, and the pressurized fluid assembly comprises a unit selected from the group consisting of an air compressor, a compressed air tank, and a combination thereof.

6. The fire suppression system of claim 3, comprising a configuration such that, during an operation of the at least one fire suppression assembly, the second conduit portion provides a fluid communication passage for a fire suppression mixture comprising foam and water, and the fire suppression mixture is propelled through the second conduit portion at a pre-determined minimum pressure.

7. The fire suppression of claim 3, further comprising a one-way valve disposed in the first conduit portion, the valve being configured to prevent a retrograde flow toward the foam source.

8. The fire suppression system of claim 1, wherein the control module is also configured to control a flow of water to the conduit.

9. The fire suppression system of claim 1, further comprising a one-way valve disposed between the water source and the conduit, the valve being configured to prevent a retrograde flow from the conduit toward the water source.

10. The fire suppression system of claim 1, further comprising a housing that substantially houses one or more of the conduit, the foam source, the sprinkler head, the means for increasing a pressure, and the control module.

11. The fire suppression system of claim 1, further comprising a plurality of one or more of:
the foam source;
the conduit;
the control module; and
the means for increasing pressure.

12. The fire suppression system of claim 1, wherein the foam source comprises a pump configured for propelling foam into the conduit at a rate controlled by the control module.

13. The fire suppression system of claim 1, wherein the conduit is configured to provide fluid communication of a fire suppression mixture to a plurality of sprinkler heads.

14. The fire suppression system of claim 13, wherein the plurality of sprinkler heads is configured for fire suppression on a single level of a multi-level structure.

15. The fire suppression system of claim 1 wherein the conduit comprises a plurality of conduits.

16. A method for providing a fire suppression system in a building structure, the method comprising the steps of:
connecting a non-fire-suppression-dedicated water source into fluid communication with a sprinkler head via at least one conduit;
providing a foam source connected in fluid communication with the at least one conduit and thereby with the sprinkler head; and
providing a control module configured to control a flow of foam from the foam source into the conduit.

17. The method of claim 16, further comprising a step of providing a compressed fluid delivery mechanism configured to deliver a compressed fluid into the conduit.

18. The method of claim 17, wherein the compressed fluid delivery mechanism comprises an air compressor and a compressed air holding tank.

19. The method of claim 17, wherein the compressed fluid delivery mechanism comprises a tank of a pressurized gas.

20. The method of claim 16, further comprising a step of installing at least one pump mechanism configured to provide a desired fluid pressure and flow through the conduit.

21. A fire suppression apparatus configured to be installed in a building structure, the apparatus comprising:
a sprinkler head;
a conduit providing fluid communication to the sprinkler head from a non-fire-suppression-dedicated water source having a water source pressure;
a control module;
a foam source, the foam source being in fluid communication with the conduit via the control module; and
a compressed gas component, the compressed gas component being in fluid communication with the conduit; and
wherein the compressed gas component is configured for increasing a pressure in the conduit above the water source pressure.

22. A fire suppression apparatus configured to be installed in a pre-existing building structure, the apparatus comprising:
a sprinkler head;
a conduit providing fluid communication to the sprinkler head from a non-fire-suppression-dedicated water source having a pressure;
a control module;
a foam source, the foam source being in fluid communication with the conduit via the control module; and
means for increasing a pressure in the conduit above the water source pressure.

23. A method of retrofitting a building with a fire suppression apparatus, the method comprising:
evaluating a building, the building not containing a fire suppression-dedicated water source, the building comprising a non-fire-suppression-dedicated water source having a water source pressure, and the building comprising a plurality of levels;
directing the installation of a plurality of sprinkler heads on a level of the building;
identifying at least one non-fire-suppression-dedicated water source having a water source pressure in the building;
directing the installation of a conduit providing fluid communication to the sprinkler heads from the identified non-fire-suppression-dedicated water source;
directing the installation of a foam apparatus in fluid communication with the conduit;
directing the installation of a means to increase the water source pressure from the identified non-fire-suppression-dedicated water source; and,
directing the installation of a control module in association with the conduit, foam apparatus, and pressure increasing means.

24. A building with a retrofitted fire suppression system comprising:
a water system, the water system consisting essentially of non-fire-suppression-dedicated water sources, at least one of the non-fire-suppression-dedicated water sources having a water source pressure;
a plurality of levels;
a plurality of sprinkler heads located in at least a majority of the floors;
a foam generating apparatus; and,
a pressure increasing apparatus configured to increase pressure between the water system and the sprinkler heads above the water source pressure;
wherein the sprinkler heads, foam generating apparatus, and pressure increasing apparatus are in fluid communication with the non-fire-suppression-dedicated water sources having a water source pressure.

25. A retrofit fire suppression system for use in a building without a fire-suppression-dedicated water source, comprising:
a plurality of sprinkler heads;
a foam generating apparatus;
a pressure increasing apparatus; and,
a means for connecting the sprinkler heads, the foam generating apparatus, and the pressure increasing apparatus in fluid communication to a non-fire-suppression-dedicated water source having a pressure.
